(19) United States
(12) Patent Application Publication
(10) Pub. No.: US 2025/0346288 A1
(43) Pub. Date: Nov. 13, 2025

(54) STEER BY WIRE STEERING APPARATUS

(71) Applicant: HL MANDO CORPORATION, Gyeonggi-do (KR)

(72) Inventor: Hyunbi KWON, Gyeonggi-do (KR)

(21) Appl. No.: 19/203,033

(22) Filed: May 8, 2025

(30) Foreign Application Priority Data
May 8, 2024 (KR) 10-2024-0060396

(51) Int. Cl. B62D 5/00

(52) U.S. Cl. CPC B62D 5/001

(57) ABSTRACT

A steer by wire type steering apparatus may include a rotating ring member that is coupled to a steering shaft and rotates in conjunction with the steering shaft, a housing that is provided with an arc-shaped guide groove centered on the steering shaft and a stopper partition that connects radially inner and outer surfaces of the guide groove, and a stopper member that is inserted into the guide groove and is supported by one end portion of the rotating ring member and rotates in a case where the steering shaft rotates.

### CROSS-REFERENCE TO RELATED APPLICATIONS

This application claims the priority of Korean Patent Application No. 10-2024-0060396 filed on May 8, 2024, in the Korean Intellectual Property Office, the disclosure of which is incorporated herein by reference.

### BACKGROUND

### Field

The present embodiments relate to a steer by wire steering apparatus, and more specifically, to a steer by wire steering apparatus capable of mechanically preventing a steering wheel from rotating any further in a case where the rotation of wheels in the steer by wire steering apparatus reaches a maximum point.

### Description of the Related Art

In general, a steering apparatus of a vehicle has been developed and applied with power steering to assist a steering wheel operation force of a driver and provide convenience in driving operation, and the power steering has been developed and applied in the form of hydraulic type that uses hydraulic pressure, electro-hydraulic type that uses hydraulic pressure and electric power of a motor simultaneously, and electric type that uses only electric power of a motor.

Recently, a steer by wire (SBW) steering apparatus has been developed and applied that uses an electric motor, such as a motor, to steer the vehicle instead of removing mechanical connecting devices such as a steering column, universal joint, or pinion shaft between the steering wheel and wheels.

However, in the case of the steer by wire steering apparatus, since there is no mechanical connection between the steering shaft and the wheels, there is a problem that the steering wheel of the driver may rotate indefinitely, which reduces a steering feel and steering stability of the driver.

Therefore, there is a growing need for research to prevent the steering wheel from rotating any further in a case where the wheel rotation reaches the maximum point thereof (in a case where the steering wheel or wheel is in a full-turn state in a typical steering apparatus).

### SUMMARY

Accordingly, the present embodiments have been devised in consideration of the background described above, and an object thereof is to provide a steer by wire steering apparatus capable of improving a steering feel and steering stability of a driver by mechanically preventing the steering wheel from rotating any further in a case where rotation of the wheel in the steer by wire steering apparatus reaches the maximum point.

Furthermore, objects of the present embodiments are not limited thereto, and other objects not mentioned will be clearly understood by those skilled in the art from the description below.

According to the present embodiments, there may be provided a steer by wire steering device including: a rotatable ring member coupled to a steering shaft and configured to be rotatable in association with the steering shaft; a housing having an arc-shaped guide groove surrounding the steering shaft; and a stopper member rotatably inserted in the arc-shaped guide groove of the housing and configured to be rotatable by being supported by a part of the rotatable ring member according to rotation of the steering shaft.

In addition, according to the present embodiments, there may be provided a steer by wire steering device including: a rotatable ring member coupled to a steering shaft and configured to be rotatable in association with the steering shaft; a housing having an arc-shaped stepped groove surrounding the steering shaft and a stopper partition formed in the stepped groove; an arc-shaped guide member having one another ends supporting one another surfaces of the stopper partition, respectively and disposed in the arc-shaped stepped groove of the housing; and a stopper member coupled to the arc-shaped guide member and configured to be rotatable by being supported by a part of the rotatable ring member according to rotation of the steering shaft.

According to these embodiments, in a case where the rotation of the wheel in the steer by wire steering apparatus reaches the maximum point, the steering wheel is mechanically prevented from rotating any further, thereby improving the steering feel and steering safety of a driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram illustrating a steer by wire steering apparatus according to the present embodiments;

FIG. 2 is a perspective view illustrating a part of the steer by wire steering apparatus according to the present embodiments;

FIG. 3 is an exploded perspective view illustrating a part of the steer by wire steering apparatus according to the present embodiments;

FIGS. 4 to 6 are perspective views illustrating a part of the steer by wire steering apparatus according to the present embodiments;

FIG. 7 is a cross-sectional view illustrating a part of the steer by wire steering apparatus according to the present embodiments;

FIG. 8 is a plan view illustrating a process of limiting rotation in the steer by wire steering apparatus of FIGS. 2 to 7;

FIG. 9 is a perspective view illustrating a part of a steer by wire steering apparatus according to the present embodiments;

FIG. 10 is an exploded perspective view illustrating a part of the steer by wire steering apparatus according to the present embodiments;

FIG. 11 is a perspective view illustrating a part of the steer by wire steering apparatus according to the present embodiments;

FIG. 12 is a cross-sectional view illustrating a part of the steer by wire steering apparatus according to the present embodiments; and

FIG. 13 is a plan view illustrating a process of limiting rotation in the steer by wire steering apparatus of FIGS. 9 to 12.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompass all the meanings of the term “can”.

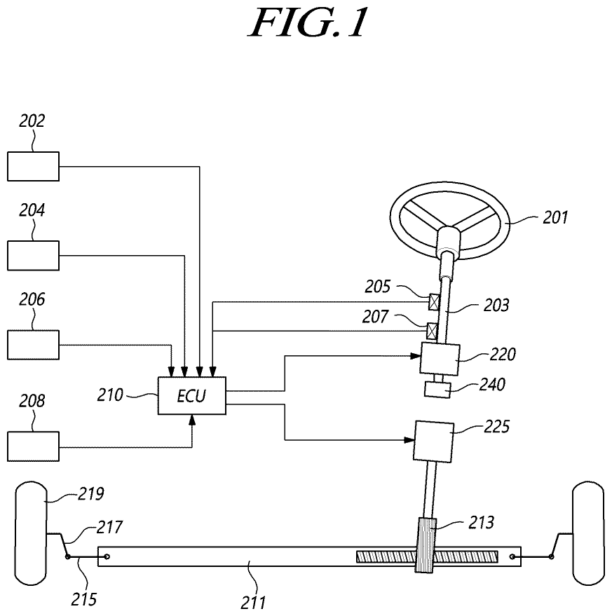

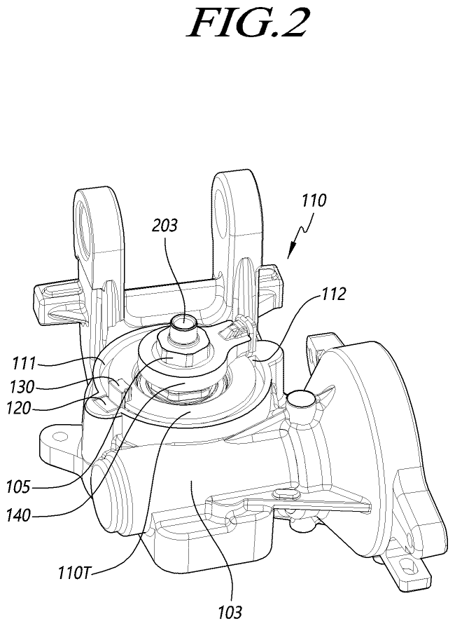

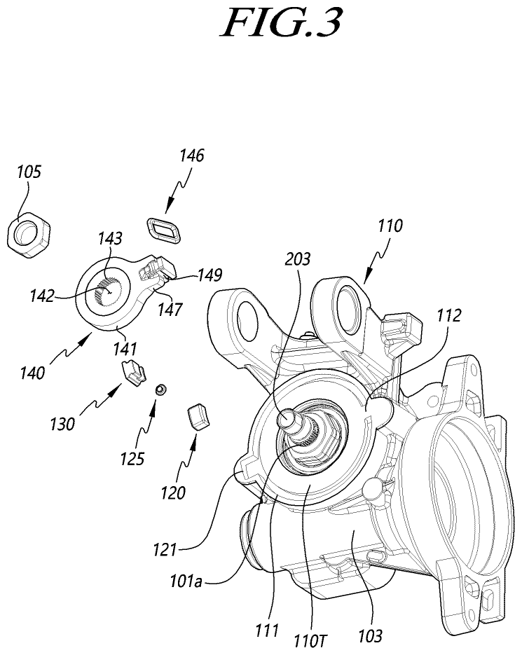

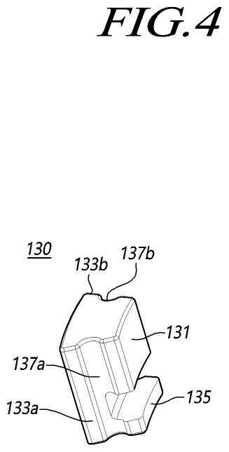

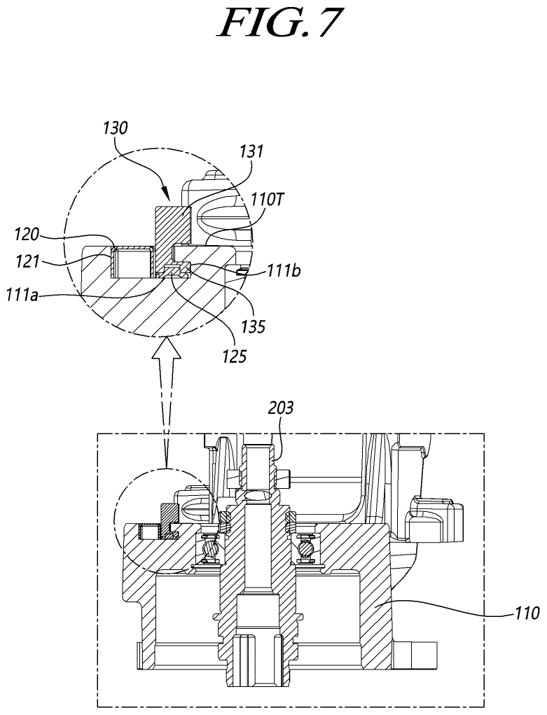

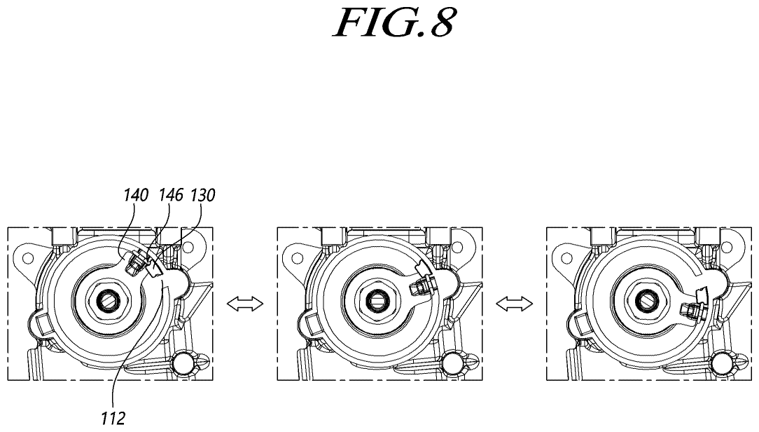

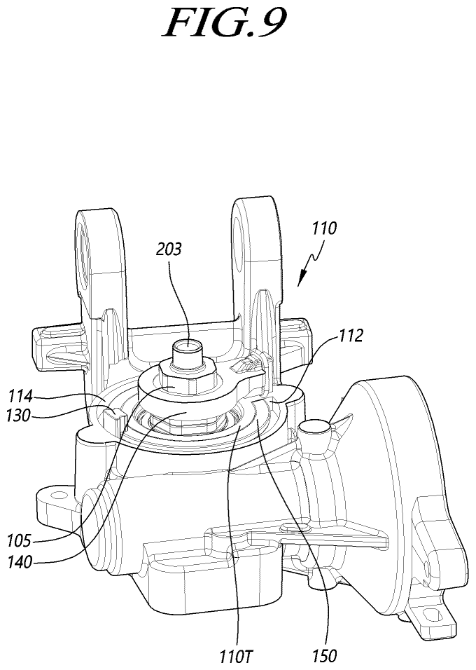

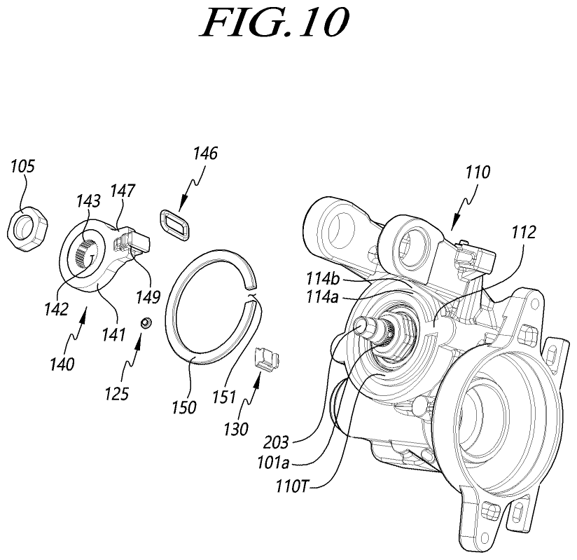

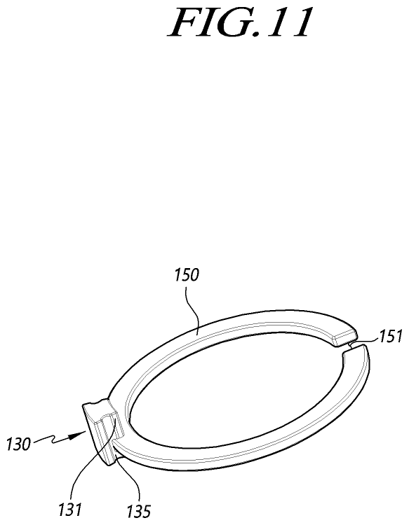

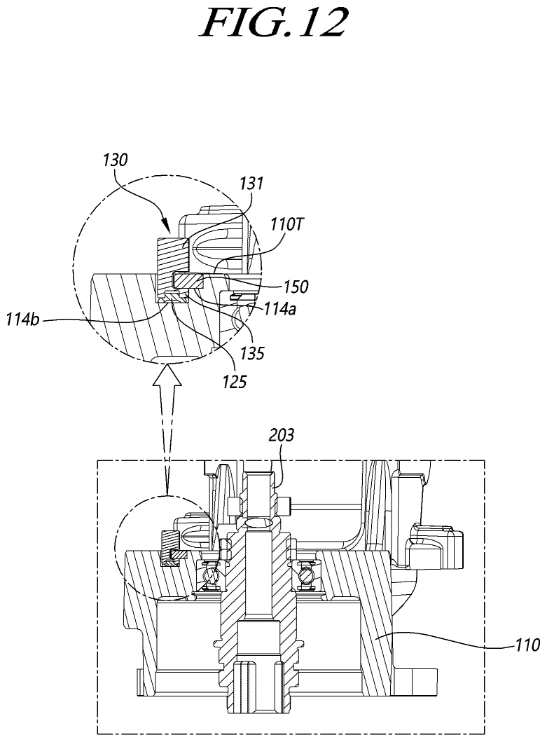

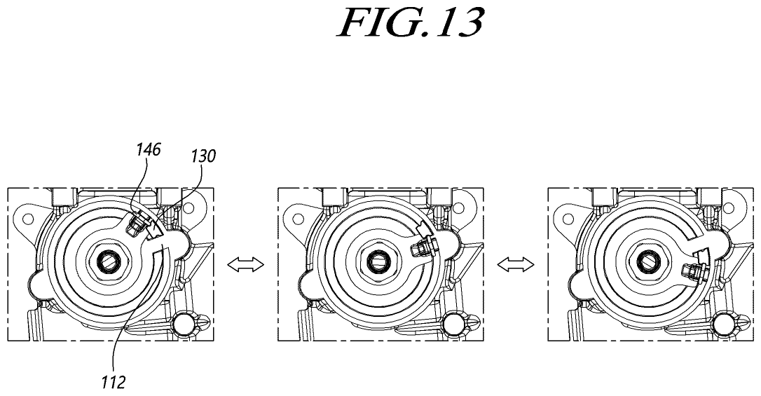

FIG. 1 is a schematic diagram illustrating a steer by wire steering apparatus according to the present embodiments, FIG. 2 is a perspective view illustrating a part of the steer by wire steering apparatus according to the present embodiments, FIG. 3 is an exploded perspective view illustrating a part of the steer by wire steering apparatus according to the present embodiments, FIGS. 4 to 6 are perspective views illustrating a part of the steer by wire steering apparatus according to the present embodiments, FIG. 7 is a cross-sectional view illustrating a part of the steer by wire steering apparatus according to the present embodiments, FIG. 8 is a plan view illustrating a process of limiting rotation in the steer by wire steering apparatus of FIGS. 2 to 7, FIG. 9 is a perspective view illustrating a part of a steer by wire steering apparatus according to the present embodiments, FIG. 10 is an exploded perspective view illustrating a part of the steer by wire steering apparatus according to the present embodiments, FIG. 11 is a perspective view illustrating a part of the steer by wire steering apparatus according to the present embodiments, FIG. 12 is a cross-sectional view illustrating a part of the steer by wire steering apparatus according to the present embodiments, and FIG. 13 is a plan view illustrating a process of limiting rotation in the steer by wire steering apparatus of FIGS. 9 to 12.

A steer by wire steering apparatus according to the present embodiment includes a rotatable ring member 140 coupled to a steering shaft 203 and configured to be rotatable in association with the steering shaft 203, a housing 110 having an arc-shaped guide groove 111 surrounding the steering shaft 203, and a stopper member rotatably inserted in the arc-shaped guide groove 111 of the housing 110 and configured to be rotatable by being supported by a part of the rotatable ring member 140 according to rotation of the steering shaft 203.

First, referring to FIG. 1, the steer by wire steering apparatus according to the present embodiments has an angle sensor 205 and a torque sensor 207 coupled to one side of the steering shaft 203 connected to a steering wheel 201, and in a case where a driver operates the steering wheel 201, the angle sensor 205 and the torque sensor 207 detect the operation and send an electric signal to an electronic control device 210 so that a steering shaft motor 220 and a pinion shaft motor 225 are operated.

The electronic control device 210 controls the steering shaft motor 220 and the pinion shaft motor 225 based on the electric signals transmitted from the angle sensor 205 and the torque sensor 207 and other electric signals transmitted from various sensors mounted on the vehicle.

The steering shaft motor 220 is connected to a reducer (see 103 in FIG. 2) that reduces the rotational speed of the motor, and during normal traveling, the steering shaft motor 220, a reaction force is provided to the steering shaft 203 so that the driver may feel a steering reaction force in the opposite direction in a case where the driver operates the steering wheel 201, and during autonomous driving, steering is performed by the control of the electronic control device 210 without the intervention of the driver's will.

The pinion shaft motor 225 slides the rack bar 211 connected to a pinion shaft 213 to steer wheels 219 on both sides through a tie rod 215 and a knuckle arm 217.

However, for convenience of explanation, the drawings in the present embodiments illustrate an example in which the angle sensor 205 and the torque sensor 207 are provided in the steering shaft 203, and a vehicle speed sensor 202 for transmitting steering information to the electronic control device 210, a pinion shaft rotation angle sensor 204, an ultrasonic sensor 206, and an image sensor 208 are provided, but in addition, a motor position sensor, various types of radars and lidars, or the like may be provided, and a detailed description thereof will be omitted below.

In the steer by wire steering apparatus, since the steering wheel 201 and the wheel 219 are not mechanically connected, a mechanical restriction is required to stop the rotation of the steering wheel 201 at a certain angle in a case where the driver operates the steering wheel 201.

That is, in a case where the rotation of the wheel 219 reaches its maximum point (in a typical steering apparatus, in a case where the steering wheel 201 or the wheel 219 is in a full-turn state), a rotation angle limiting member 240 is provided to mechanically limit the rotation angle of the steering shaft 203 so that the steering wheel 201 does not rotate any further, thereby providing the driver with an accurate steering feel.

The rotation angle limiting member 240 is provided at the lower end portion of a steering column (not illustrated) and is coupled to the housing 110 together with the steering shaft motor 220, the reducer 103, or the like.

In the present embodiments, the reducer 103 includes a worm shaft that is connected to the steering shaft motor 220 and rotated, a worm wheel that is coupled to the steering shaft 203 and rotates by the worm shaft, or the like, and the rotation of the motor may be reduced by a gear ratio of the worm shaft and the worm wheel.

The rotation angle limiting member 240 includes the rotation ring member 140 that is coupled to the steering shaft 203 and rotates in conjunction with the steering shaft 203, the housing 110 that is provided with the arc-shaped guide groove 111 centered on the steering shaft 203 and the stopper partition 112 that connects the radially inner and outer surfaces of the guide groove 111, the stopper member 130 that is inserted into the guide groove 111 and is supported by one end portion of the rotation ring member 140 and rotates in a case where the steering shaft 203 rotates, a rotatable ring fixing member 105 that is coupled to the steering shaft 203 and fixes the axial position of the rotation ring member 140, or the like.

An upper surface 110T of the housing 110 is formed as a plane perpendicular to the steering shaft 203, and the housing 110 includes the arc-shaped guide groove 111 centered on the steering shaft 203 and the stopper partition 112 connecting the inner and outer surfaces of the guide groove 111.

The stopper member 130 is inserted into the guide groove 111, and in a case where the steering shaft 203 rotates, one end portion of the rotatable ring member 140 in conjunction with the steering shaft 203 is supported by the stopper member 130, and the rotation angle of the rotatable ring member 140 is limited.

The rotatable ring member 140 that is coupled to the steering shaft 203 and rotates in conjunction with the steering shaft 203 includes a ring-shaped shaft coupling portion 141 having a coupling hole 142 to which the steering shaft 203 is coupled, and a stopper support portion 147 that protrudes radially from the outer peripheral surface of the shaft coupling portion 141 and is supported by the stopper member 130.

In these embodiments, the shaft coupling portion 141 and the stopper support portion 147 are illustrated as being formed integrally as an example, but the present disclosure is not necessarily limited thereto, and the shaft coupling portion 141 and the stopper support portion 147 may be formed separately and then coupled.

On the inner peripheral surface of the coupling hole 142, a plurality of inner peripheral serrations 143 are formed long in the axial direction, and on the outer peripheral surface of the steering shaft 203 inserted into and coupled to the coupling hole 142, an outer peripheral serration 101a that interlocks with the inner peripheral serrations 143 is provided long in the axial direction.

Accordingly, in a case where the steering shaft 203 rotates, the rotatable ring member 140 may rotate in conjunction with the steering shaft 203 without spinning.

An elastic member 146 that supports the stopper member 130 may be coupled to the stopper support portion 147 of the rotatable ring member 140, and a fixing groove 149 to which the elastic member 146 is coupled may be provided on the outer peripheral surface of the stopper support portion 147.

Accordingly, in a case where the rotatable ring member 140 rotates and is supported by the stopper member 130, the elastic member 146 may be supported while reducing shock and noise.

The guide groove 111 provided in the housing 110 may include a first guide groove 111a formed vertically on the upper surface 110T of the housing 110, as illustrated in FIG. 7, and a second guide groove 111b recessed radially inward on the lower surface of the first guide groove 111a and connected to the first guide groove 111a.

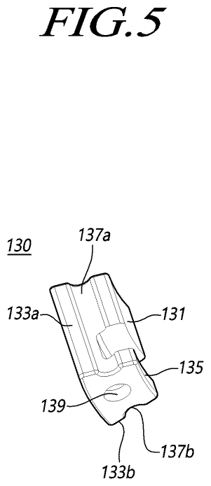

Moreover, referring to FIGS. 4 and 5 together with FIG. 7, the stopper member 130 includes a first support portion 131 supported by the upper surface 110T of the housing 110, and a second support portion 135 whose outer surface is supported by the outer surface of the first guide groove 111a and whose inner surface is axially spaced from the first support portion 131 and is inserted into and supported by the second guide groove 111b.

Accordingly, in a case where the rotatable ring member 140 supports and rotates the stopper member 130, the first support portion 131 supports the upper surface 110T of the housing 110 and the second support portion 135 supports the second guide groove 111b to rotate, so that the stopper member 130 may move to a fixed position without being detached.

On both sides of the outer end of the stopper member 130, partition support portions 133a and 133b supported by one side and the other side of the stopper partition 112 are provided.

In addition, seating grooves 137a and 137b by which the elastic member 146 is supported in a case where the rotatable ring member 140 rotates may be provided on both side surfaces of the stopper member 130.

Accordingly, in case where the rotatable ring member 140 rotates and is supported by the stopper member 130, the stopper member 130 is supported at an accurate position, so that the rotation of the stopper member 130 may be accurately achieved.

In addition, the first guide groove 111a is provided with an extension groove 121 that extends radially outward, and a cap 120 that supports the outer surface of the stopper member 130 in the radial direction may be coupled to the extension groove 121.

Accordingly, in a case where the stopper member 130 is assembled to the guide groove 111, the stopper member 130 is assembled to the first guide groove 111a and the second guide groove 111b through the extension groove 121, and in a case where the assembly is completed, the cap 120 is coupled to the extension groove 121, thereby facilitating the assembly of the stopper member 130 while preventing the stopper member 130 from being detached.

Additionally, an axial support 125 that axially supports the stopper member 130 may be coupled between the stopper member 130 and the bottom surface of the first guide groove 111a.

That is, as illustrated in FIG. 7, the axial support 125 is compressed and coupled between the stopper member 130 and the bottom surface of the first guide groove 111a so as to absorb the gap between the second support portion 135 and the bottom surface of the first guide groove 111a, thereby supporting the stopper member 130 in the axial direction.

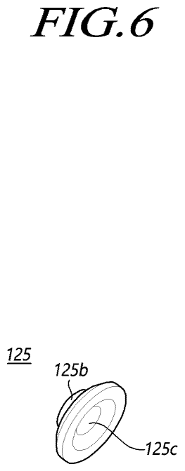

Moreover, as illustrated in FIGS. 5 and 6, an insertion groove 139 is formed on the lower surface of the stopper member 130, and an insertion protrusion 125b that is coupled to the insertion groove 139 is provided on the upper side of the axial support 125, so that the axial support 125 may axially support the stopper member 130 at an accurate position.

In addition, the lower surface of the axial support 125 is provided with a bottom groove 125c so that axial elastic deformation may be easily achieved, so that the axial support 125 is compressed and coupled between the stopper member 130 and the bottom surface of the first guide groove 111a.

The operating mechanism of these embodiments is explained below with reference to FIG. 8.

FIG. 8 sequentially illustrates the steering wheel from the left drawing to the right drawing from the point where clockwise rotation is completed to the point where counterclockwise rotation stops.

First, the left drawing of FIG. 8 illustrates a state in which the clockwise rotation of the steering wheel is completed, and in this case, the stopper member 130 is supported by the left side of the stopper partition 112 to stop the rotation, and at the same time, the elastic member 146 is supported by the stopper member 130, and the rotation of the rotatable ring member 140 is limited, so that the driver may detect that the steering wheel has been fully turned clockwise.

Thereafter, in a case where the driver turns the steering wheel counterclockwise, the rotatable ring member 140 rotates counterclockwise and, as illustrated in the center drawing of FIG. 8, the rotatable ring member 140 supports the right side of the stopper member 130 and may move together counterclockwise.

Thereafter, in a case where the rotatable ring member 140 supports the stopper member 130 and rotates together further counterclockwise, the stopper member 130 is supported by the right side of the stopper partition 112 as illustrated in the drawing on the right, so that the rotation stops, and at the same time, the elastic member 146 is supported by the stopper member 130, and the rotation of the rotatable ring member 140 is limited, so that the driver may detect that the steering wheel has been fully turned counterclockwise.

In addition, referring to FIGS. 9 to 13 together with FIGS. 1 to 8, the steer by wire steering apparatus according to the present embodiments includes the rotatable ring member 140 coupled to the steering shaft 203 and configured to rotatable in association with the steering shaft 203, the housing 110 having an arc-shaped stepped groove 114 surrounding the steering shaft 203 and a stopper partition 112 formed in the stepped groove 114, an arc-shaped guide member 150 having one and another ends supporting one another surfaces of the stopper partition 112, respectively and disposed in the arc-shaped stepped groove 114 of the housing 110, and a stopper member 130 coupled to the arc-shaped guide member 150 and configured to be rotatable by being supported by a part of the rotatable ring member 140 according to rotation of the steering shaft 203.

In addition, the present embodiments may further include the rotatable ring fixing member 105 coupled to the steering shaft 203 to axially support the rotatable ring member 140 and the stopper member 130.

The stopper member 130 is coupled to the arc-shaped guide member 150, and one end portion of the rotatable ring member 140 in conjunction with the steering shaft 203 in a case where the steering shaft 203 rotates is supported by the stopper member 130 and rotates, and the rotation angle of the rotatable ring member 140 is limited.

The rotatable ring member 140 may include the ring-shaped shaft coupling portion 141 having the coupling hole 142 to which the steering shaft 203 is coupled, and the stopper support portion 147 that extends radially from one side of the outer peripheral surface of the shaft coupling portion 141 and is supported by the stopper member 130.

The rotatable ring fixing member 105, rotatable ring member 140, and stopper member 130 illustrated in FIGS. 9 to 13 are the same as those illustrated in FIGS. 1 to 8, so detailed descriptions thereof will be omitted below.

On the inner peripheral surface of the coupling hole 142, the plurality of inner peripheral serrations 143 are formed long in the axial direction, and on the outer peripheral surface of the steering shaft 203 inserted into and coupled to the coupling hole 142, the outer peripheral serration 101a that interlocks with the inner peripheral serrations 143 is provided long in the axial direction.

Accordingly, in a case where the steering shaft 203 rotates, the rotatable ring member 140 may rotate in conjunction with the steering shaft 203 without spinning.

The elastic member 146 that supports the stopper member 130 may be coupled to the stopper support portion 147, and the fixing groove 149 to which the elastic member 146 is coupled may be provided on the outer peripheral surface of the stopper support portion 147.

Accordingly, in a case where the rotatable ring member 140 rotates and is supported by the stopper member 130, the elastic member 146 may be supported while reducing shock and noise.

As illustrated in FIGS. 10 and 12, the stepped groove 114 may include a first stepped groove 114a which is formed vertically stepwise on the upper surface 110T of the housing 110 and to which the arc-shaped guide member 150 is coupled, and a second stepped groove 114b formed vertically stepwise and recessed on a step surface extending radially outward from the lower surface of the first stepped groove 114a.

The arc-shaped guide member 150 is formed in an arc shape with a cut portion 151 on one side, as illustrated in FIG. 11, and is formed to a certain thickness and is pressed into and coupled to the first stepped groove 114a.

Moreover, the stopper member 130 is coupled to the outer periphery side of the arc-shaped guide member 150 and inserted into the first stepped groove 114a and the second stepped groove 114b, and rotation is performed along the outer peripheral surface of the arc-shaped guide member 150.

The stopper member 130 may include the first support portion 131 supported by the upper surface of the arc-shaped guide member 150, and the second support portion 135 whose outer surface is supported by the outer surface of the second stepped groove 114b and whose inner surface is axially spaced from the first support portion 131 and supported by the lower surface of the arc-shaped guide member 150.

Accordingly, in a case where the rotatable ring member 140 supports and rotates the stopper member 130, the first support portion 131 supports the upper surface of the arc-shaped guide member 150 and the second support portion 135 supports the second stepped groove 114b to rotate, so that the stopper member 130 may move to a fixed position without being detached.

The seating grooves 137a and 137b by which the elastic member 146 is supported in a case where the rotatable ring member 140 rotates may be provided on both side surfaces of the stopper member 130.

Accordingly, in a case where the rotatable ring member 140 rotates and is supported by the stopper member 130, the stopper member 130 is supported at an accurate position, so that the rotation of the stopper member 130 may be accurately achieved.

The axial support 125 that axially supports the stopper member 130 may be coupled between the stopper member 130 and the bottom surface of the second stepped groove 114b.

That is, as illustrated in FIG. 12, the axial support 125 is compressed and coupled between the stopper member 130 and the bottom surface of the second stepped groove 114b so as to absorb the gap between the second support portion 135 and the bottom surface of the arc-shaped guide member 150, thereby supporting the stopper member 130 in the axial

Moreover, as illustrated in FIGS. 5 and 6, the insertion groove 139 is formed on the lower surface of the stopper member 130, and an insertion protrusion 125b that is coupled to the insertion groove 139 is provided above the axial support 125, so that the axial support 125 may axially support the stopper member 130 at an accurate position.

In addition, the lower surface of the axial support 125 is provided with the bottom groove 125c so that axial elastic deformation may be easily achieved, so that the axial support 125 is compressed and coupled between the stopper member 130 and the bottom surface of the second stepped groove 114b.

The operating mechanism of these embodiments is explained below with reference to FIG. 13.

FIG. 13 sequentially illustrates the steering wheel from the left drawing to the right drawing from the point where clockwise rotation is completed to the point where counterclockwise rotation stops.

First, the left drawing of FIG. 13 illustrates a state in which the clockwise rotation of the steering wheel is completed, and in this case, the stopper member 130 is supported by the left side of the stopper partition 112 to stop the rotation, and at the same time, the elastic member 146 is supported by the stopper member 130, and the rotation of the rotatable ring member 140 is limited, so that the driver may detect that the steering wheel has been fully turned clockwise.

Thereafter, in a case where the driver turns the steering wheel counterclockwise, the rotatable ring member 140 rotates counterclockwise and, as illustrated in the center drawing of FIG. 13, the rotatable ring member 140 supports the right side of the stopper member 130 and may move together counterclockwise.

Thereafter, in a case where the rotatable ring member 140 supports the stopper member 130 and rotates together further counterclockwise, the stopper member 130 is supported by the right side of the stopper partition 112 as illustrated in the drawing on the right, so that the rotation stops, and at the same time, the elastic member 146 is supported by the stopper member 130, and the rotation of the rotatable ring member 140 is limited, so that the driver may detect that the steering wheel has been fully turned counterclockwise.

As described above, according to these embodiments, in a case where the rotation of the wheel in the steer by wire steering apparatus reaches the maximum point, the steering wheel is mechanically prevented from rotating any further, thereby improving the steering feel and steering safety of the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steer by wire steering apparatus comprising:
a rotatable ring member coupled to a steering shaft and configured to be rotatable in association with the steering shaft;
a housing having an arc-shaped guide groove surrounding the steering shaft; and
a stopper member rotatably inserted in the arc-shaped guide groove of the housing and configured to be rotatable by being supported by a part of the rotatable ring member according to rotation of the steering shaft.

2. The steer by wire steering apparatus of claim 1, further comprising a rotatable ring fixing member coupled to the steering shaft to fix an axial position of the rotatable ring member.

3. The steer by wire steering apparatus of claim 1, wherein the rotatable ring member includes:
a shaft coupling portion having a coupling hole to which the steering shaft is coupled, and
a stopper support portion protruding radially from an outer peripheral surface of the shaft coupling portion and configured to support the stopper member.

4. The steer by wire steering apparatus of claim 3, wherein the coupling hole of the shaft coupling portion of the rotatable ring member has a toothed inner surface, and the steering shaft has a toothed outer surface interlocked with the toothed inner surface of the coupling hole of the shaft coupling portion of the rotatable ring member.

5. The steer by wire steering apparatus of claim 3, further comprising an elastic member mounted to the stopper support portion of the rotatable ring member to be contacted with the stopper member.

6. The steer by wire steering apparatus of claim 5, wherein the arc-shaped guide groove includes:
a first guide groove recessed in an axial direction of the steering shaft from an upper surface of the housing, and
a second guide groove extended from a lower portion of the first guide groove in a radial direction toward the steering shaft.

7. The steer by wire steering apparatus of claim 6, wherein the stopper member includes:
a first support portion positioned above the upper surface of the housing, and
a second support portion spaced apart from the first support portion, and having an outer part disposed in the first guide groove recessed in the axial direction and an inner part disposed in the second guide groove extended from the first guide groove in the radial

8. The steer by wire steering apparatus of claim 7, wherein the stopper member has seating grooves on both side surfaces to support the elastic member mounted to the stopper support portion of the rotatable ring member.

9. The steer by wire steering apparatus of claim 7, further comprising a cap disposed in an extension groove extending from the first guide groove in a radial direction away from the first guide groove.

10. The steer by wire steering apparatus of claim 7, further comprising an axial support axially supporting the stopper member and disposed between the stopper member and a bottom surface of the first guide groove.

11. The steer by wire steering apparatus of claim 10, wherein an insertion groove is formed on a lower surface of the stopper member and the axial support has an insertion protrusion coupled to the insertion groove of the stopper member.

12. A steer by wire steering apparatus comprising:
a rotatable ring member coupled to a steering shaft and configured to be rotatable in association with the steering shaft;
a housing having an arc-shaped stepped groove surrounding the steering shaft and a stopper partition formed in the stepped groove;
an arc-shaped guide member having one and another ends supporting one and another surfaces of the stopper partition, respectively, and disposed in the arc-shaped stepped groove of the housing; and
a stopper member coupled to the arc-shaped guide member and configured to be rotatable by being supported by a part of the rotatable ring member according to rotation of the steering shaft.

13. The steer by wire steering apparatus of claim 12, further comprising a rotatable ring fixing member coupled to the steering shaft to fix an axial position of the rotatable ring member.

14. The steer by wire steering apparatus of claim 12, wherein the rotatable ring member includes:
a shaft coupling portion having a coupling hole to which the steering shaft is coupled, and
a stopper support portion protruding radially from an outer peripheral surface of the shaft coupling portion and configured to support the stopper member.

15. The steer by wire steering apparatus of claim 14, wherein the coupling hole of the shaft coupling portion of the rotatable ring member has a toothed inner surface, and the steering shaft has a toothed outer surface interlocked with the toothed inner surface of the coupling hole of the shaft coupling portion of the rotatable ring member.

16. The steer by wire steering apparatus of claim 14, further comprising an elastic member mounted to the stopper support portion to be contacted with the stopper member.

17. The steer by wire steering apparatus of claim 16, wherein the stepped groove includes:
a first stepped groove recessed in an axial direction of the steering shaft from an upper surface of the housing, wherein the guide member is disposed in the first stepped groove, and
a second stepped groove extending from the first stepped groove and further recessed in the axial direction of the steering shaft than the first stepped groove.

18. The steer by wire steering apparatus of claim 17, wherein the stopper member includes:
a first support portion positioned above an upper surface of the guide member, and
a second support portion spaced apart from the first support portion, and having an outer part disposed in the second stepped groove and an inner part spaced from the first support portion and supported by a lower surface of the guide member.

19. The steer by wire steering apparatus of claim 18, wherein the stopper member has seating grooves on both side surfaces to support the elastic member mounted to the stopper support portion.

20. The steer by wire steering apparatus of claim 18, wherein an axial support axially supporting the stopper member and disposed between the stopper member and a bottom surface of the second stepped groove.
